(19) United States
(12) Patent Application Publication
(10) Pub. No.: US 2009/0102669 A1
(43) Pub. Date: Apr. 23, 2009

(54) ALARM CLOCK WITH A PROXIMITY DETECTOR

(76) Inventor: Shyuh Der LIN, Jhubei City (TW)

Correspondence Address: Mr. Brian R. Coleman;Perkins Coie. LLP, 101 Jefferson Drive, Menlo Park, CA, 94025-1114, US

(21) Appl. No.: 11/874,121

(22) Filed: Oct. 17, 2007

(51) Int. Cl. G08B 23/00

(52) U.S. Cl. 340/575

(57) ABSTRACT

The present invention offers an alarm clock with a proximity detector consists of an alarm clock, an object proximity detector and sound generator. The alarm clock can be an analog clock or a digital clock with LCD display. When the time of clock meets the setting time, alarm signal will come from the sound generator, it is not necessary to touch a push button switch of the alarm clock to control the alarm signal, only the proximity of human body or a finger can stop the alarm signal of an alarm clock. The sensor of the object proximity detector can be a capacitive proximity sensor or a magnetic proximity sensor. Most of the technology use capacitive sensor because of low power consumption and low cost.

### BACKGROUND OF THE INVENTION

1. Field of the Invention

The present invention relates to an alarm clock with snooze function. In particular, the present invention uses the technology of object proximity detector to control the function of an alarm clock.

2. Description of the Related Art

There are two major types of alarm clock, FIG. 1 is an analog alarm clock with an alarm setting switch and a push button switch of the prior art. Analog alarm clock 10 with hour hand 11, minute hand 12, second hand 13 and alarm hand 14, a push button switch 15 and an alarm button switch 16. The push button switch 15 is used to stop the alarm signal. The alarm button switch 16 is used to enable the alarm. FIG. 2 is a digital alarm clock with function setting switches and a push button switch of the prior art. Digital alarm clock 20 with panel display 21, a plurality of function setting switch 22 and a push button switch 23. The push button switch 23 is used to stop or stop temporally the alarm signal. The push button switch 23 is used to stop the alarm signal temporally in the situation people is waken up by the clock alarm signal from the sleep state. There is a little difficulty to reach the push button 23 quickly. And for most alarm clocks, the size of the push button switch 23 is very big for easy touch.

What is needed is an alarm clock with an object proximity detector which is used to replace the push button switch. The object proximity detector can sense the proximity of a human body within 20 to 30 centimeters. So we can use our hand to trigger the clock alarm to stop easily. And it is not necessary to press a push button switch to stop the alarm signal of an alarm clock.

There are many technologies which can be used as the object proximity detector in the alarm clock of the invention. One of the technologies is invented by the inventor in U.S. Pat. No. 7,023,221 B1.

The other technologies of the object proximity detector designed by the other inventors are described in U. S. Pat. No. 5,374,787, U.S. Pat. No. 5,495,077, U.S. Pat. No. 5, 841,078, to Robert J. Miller et al., U.S. Pat. No. 5,914,465, U.S. Pat. No. 6,239,389B1, to Timothy P. Allen et al., U.S. Pat. No. 6,028,271 and U.S. Pat. No. 6,610,936B2, to David W. Gillespie et al., U.S. Pat. No. 6,452,514B1 and U.S. Pat. No. 6,466,036 B1 to Harald Philipp. These technologies can be used as the object proximity detector in the invention of an alarm clock with proximity detector.

### OBJECTS OF THE INVENTION

It is therefore an object of the invention to provide an alarm clock with a proximity detector to give a convenient means to stop the alarm signal of an alarm clock.

It is another object of the invention to provide an alarm clock with a proximity detector with low power consumption.

### DISCLOSURE OF THE INVENTION

The present invention teaches a structure to control the alarm signal of an alarm clock in a convenient way. It is not necessary to touch a push button switch of the alarm clock to control the alarm signal. Only the proximity of human body can stop the alarm signal of an alarm clock.

An alarm clock with a proximity detector of the invention comprises of an alarm clock, an object proximity detector and sound generator. The alarm clock can be an analog clock or a digital clock with LCD display. When the time of clock meets the setting time, alarm signal will come from the sound generator. The sound generator can be a speech IC or a melody generator IC with a speaker. The sound generator can also be a mechanical bell driven by a motor.

The sensor of the object proximity detector can be a capacitive proximity sensor or a magnetic proximity sensor. Most of the technology use capacitive sensor because of low power consumption and low cost.

There are two major technologies of capacitive proximity sensor. Both technologies can use one metal plate or two metal plates as sensor. Also metal wire can be used as the sensor.

One of the technologies uses the variation of frequency of an oscillator to detect the proximity of an object to the sensor. The other technologies use the variation of amplitude of an oscillator to detect the proximity of an object to the sensor.

In the normal condition, the object proximity detector stays at standby state to save the power. When the time of the alarm clock meets the setting time, the alarm clock will trigger the sound generator and object proximity detector. The object proximity detector enters the operating state and can detect the proximity of an object. At this time, close your hand or an object to the metal plate will make the sound generator to stop. If the alarm clock is a clock with snooze function, the sound generator will alarm after a period of time, proximity to the sensor plate will stop the alarm again.

### BRIEF DESCRIPTION OF THE DRAWINGS

The foregoing and other advantages of the invention will be more fully understood with reference to the description of the best embodiment and the drawing wherein:

FIG. 1 (prior art) is an analog alarm clock with an alarm setting switch and a push button switch.

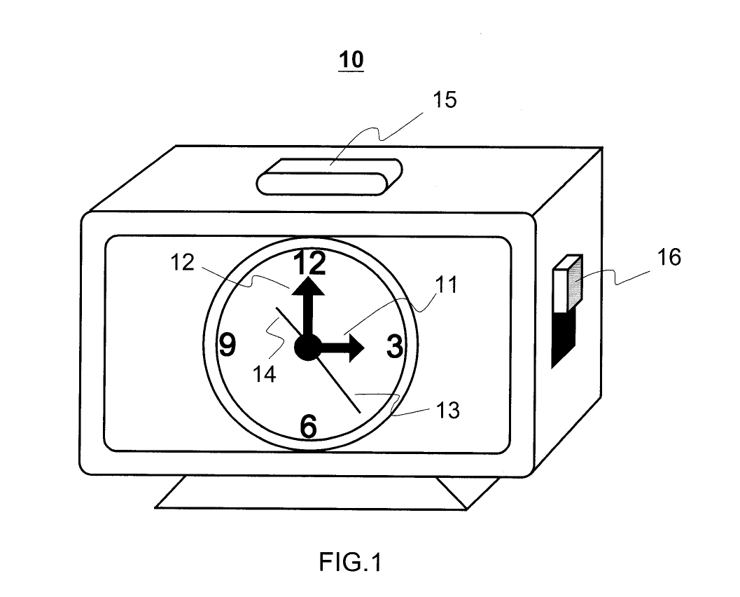

FIG. 2 (prior art) is a digital alarm clock with function setting switches and a push button switch.

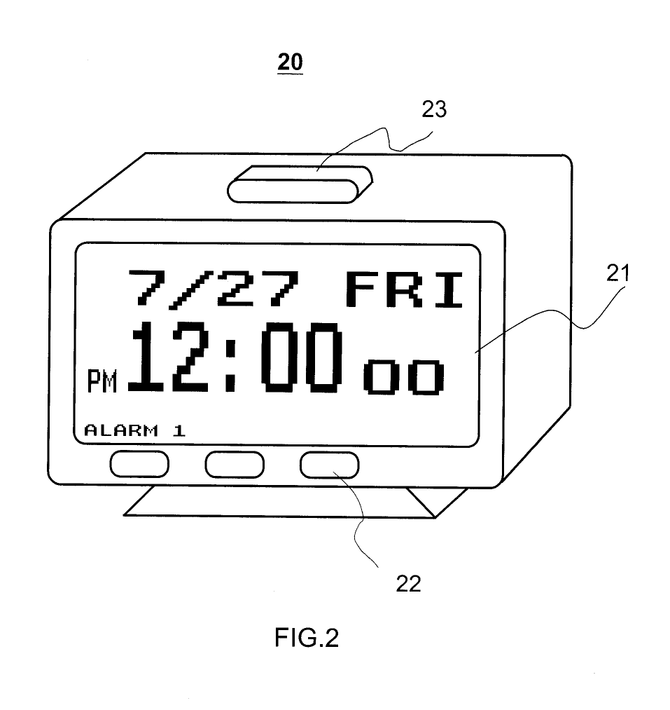

FIG. 3 is an analog alarm clock with object proximity detector according to one embodiment of the present invention.

FIG. 4 is a digital alarm clock with object proximity detector according to one embodiment of the present invention.

FIG. 5 is a block diagram of an alarm clock with object proximity detector according to one embodiment of the present invention.

FIG. 6 is a block diagram of object proximity detector.

FIG. 7 is a block diagram of another object proximity detector.

### DESCRIPTION OF THE PREFERRED EMBODIMENTS

Proximity sensing technology is useful for application in an alarm clock. When proximity sensing technology is used in an alarm clock, it is very convenient to control the sound generator of the alarm clock.

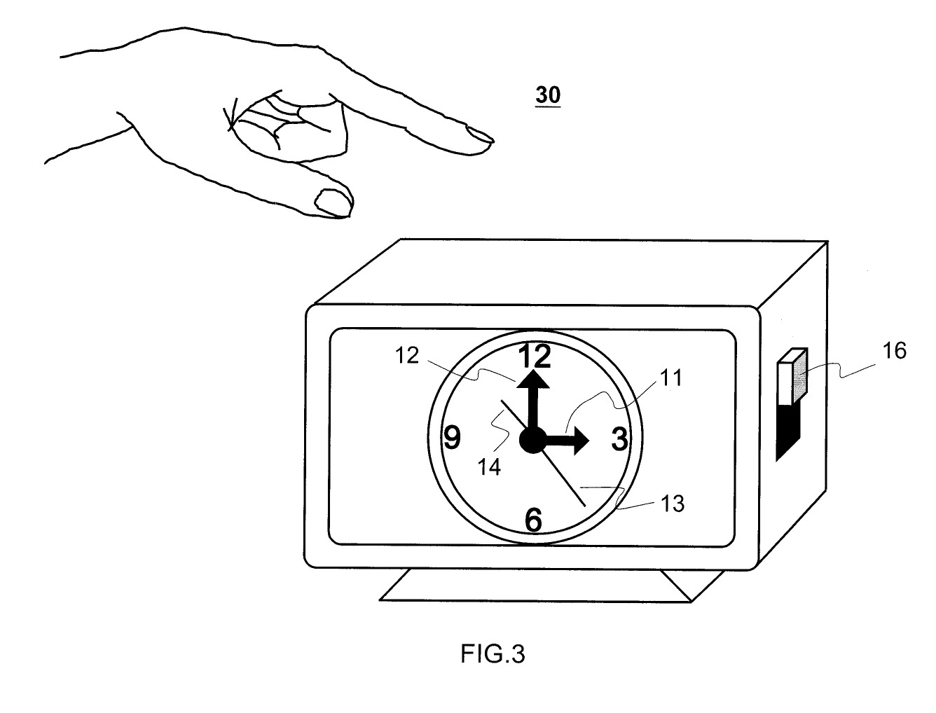

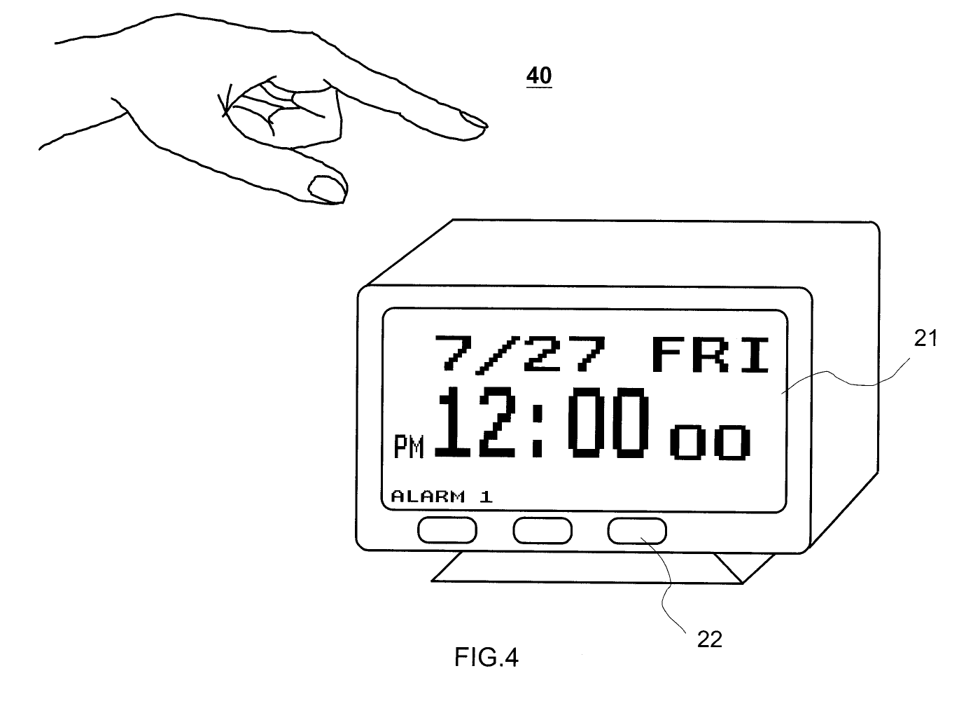

One embodiment of an alarm clock with proximity detector of the present invention consists of at least an alarm clock, an object proximity detector and a sound generator. FIG. 3 is an analog alarm clock 30 with object proximity detector. Analog alarm clock 30 has hour hand 11, minute hand 12, second hand 13, alarm hand 14, an object proximity detector (not shown) and a sound generator (not shown). FIG.4 is a digital alarm clock 40 with object proximity detector. Digital alarm clock 40 has panel display 21, a plurality of function setting switch 22. Inside the case of the alarm clock, there is an object proximity detector (not shown). The sensor consists of a pair of sensor plates (not shown) or a single sensor plate in the object proximity detector. The sensor is a capacitive coupling device used to detect the proximity of an object or a finger to the alarm clock.

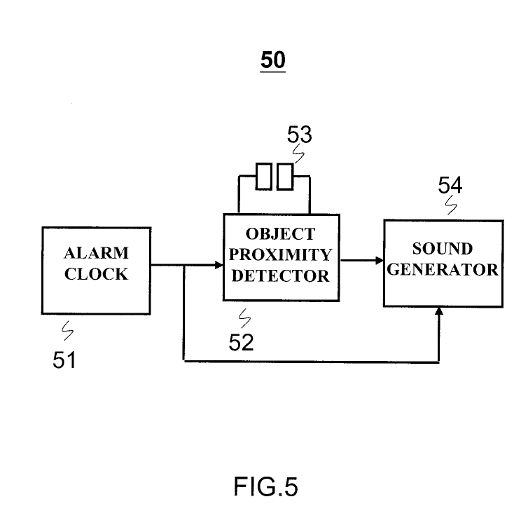

FIG. 5 is the block diagram of an alarm clock 50 with object proximity detector. The system consists of an alarm clock 51, an object proximity detector 52, a pair of sensor plates 53 and sound generator 54. The alarm clock 51 can be an analog alarm clock or a digital alarm clock. The sound generator 54 can be a mechanical bell driven by a motor or a speaker driven by a speech or melody integrated circuit. There are some technologies to design the object proximity detector.

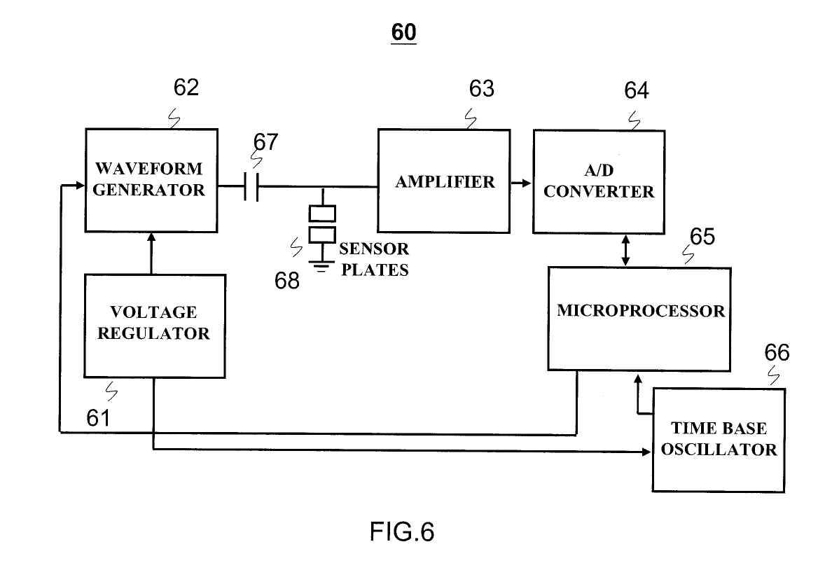

FIG. 6 is a block diagram of object proximity detector 60 uses capacitive coupling technology. The circuit comprises of a voltage regulator 61, a waveform generator 62, an amplifier 63, an A/D converter 64, a microprocessor 65, a time base oscillator 66, a coupling capacitor 67 and sensor plates 68. The voltage regulator 61 supplies a fixed output voltage to the waveform generator 62 and time base oscillator 66. The amplitude of the waveform comes from the waveform generator 62 will keep constant and independent of the variation of the power supply. When the waveform goes through the coupling capacitor 67, the amplitude will decrease because of the charge sharing of the capacitance of the sensor plates 68. When an object or a finger is in proximity of the sensor plates 68, the capacitance of the sensor plates will change and the amplitude of the waveform at the input of the amplifier 63 will change also. In order to detect the variation of the capacitance of the sensor plates, the signal is amplified by amplifier 63 and converted to digital signal by A/D converter 64. After the processing of microprocessor 65, the proximity of an object to the sensor plates 68 will be detected by the variation of the capacitance of the sensor plates 68.

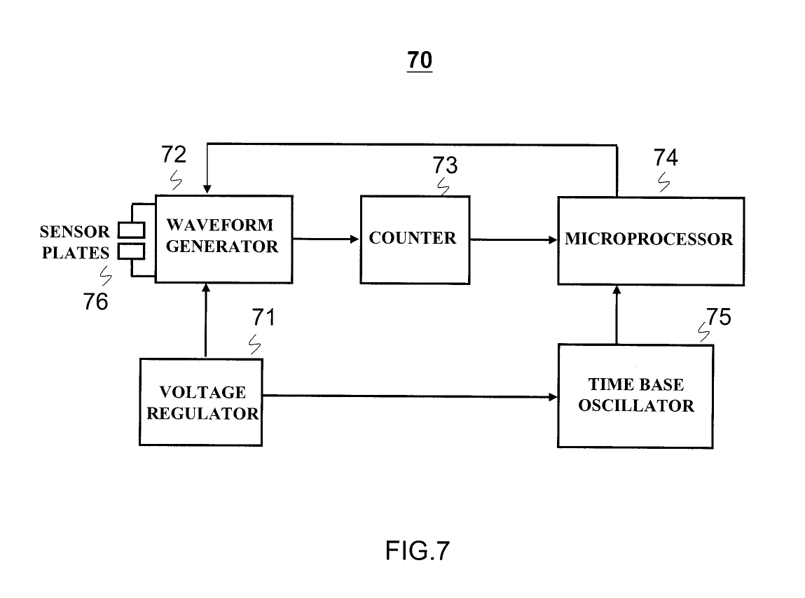

FIG. 7 is a block diagram of the other object proximity detector 70 uses capacitive coupling technology. The circuit comprises of a voltage regulator 71, a waveform generator 72, a counter 73, a microprocessor 74, a time base oscillator 75 and sensor plates 76.

The waveform generator 72 is a RC oscillator. The voltage regulator 71 is used to keep the frequency of the oscillators independent of the power supply. The frequency of the RC oscillator is determined by the resistor and the capacitor inside the waveform generator 71, and also determined by the capacitance of the sensor plates 76. The proximity of an object or a finger to the sensor plates 76 will change the capacitance of the sensor plates and the frequency of the waveform generator 72. Counting the frequency by the counter 73, the variation of the frequency will be calculated. The microprocessor 74 is used to process the counter number NX from the counter 73. From the processing of the microprocessor 74, the proximity of an object to the sensor plates 76 can be determined.

Most of the alarm clocks use battery as the power supply, and reduction of power consumption is very important. In order to reduce the power consumption, the object proximity detector can not be always in the operation state. FIG. 5 is a block diagram of an alarm clock with object proximity sensor. Before the triggering of the alarm signal, the object proximity detector is in standby state and there is not power consumption. In an analog alarm clock there is an alarm hand used to set the alarm time of the clock. There is a switch in the clock. One of the terminals of the switch is connected to power supply; the other of the terminals is connected to the object proximity detector 52 and sound generator 54. The switch will be closed when the time of the clock meets the setting time of the clock; and a triggering signal from the power supply will go through the switch to the object proximity detector 52 and sound generator 54. In a digital alarm clock the triggering signal can be generated directly inside the integrated circuit or the microprocessor of the digital alarm clock. After receiving the triggering signal, alarm signal will be generated by the sound generator 54 and the object proximity detector 52 enters the operating state. In the operating state, the object proximity detector 52 will be ready for detecting the proximity of an object. If an object is detected in proximity of the sensor plates, the alarm signal will stop and object proximity detector 52 enters the standby state. In an alarm clock with snooze function, the triggering signal will come from the alarm clock again after a period of time. At this time the sound generator 54 alarms again and the object proximity detector 52 enters operating state and waiting for the proximity of an object to the sensor plates.

In order to ensure the stability and the sensitivity of the object proximity detector, the frequency of the waveform generator and time base oscillator must be independent of the variation of the power supply. The voltage regulator 61 in FIG. 6 and voltage regulator 71 in FIG. 7 are used to provide stable voltage to the waveform generator and time base oscillator.

Although specific embodiments of the invention have been disclosed, it will be understood by those having skill in the art that minor changes can be made to the form and details of the specific embodiments disclosed herein, without departing from the scope of the invention. The embodiments presented above are for purposes of example only and are not to be taken to limit the scope of the appended claims.

What is claimed as new and desired to be protected by Letters Patent of the United States is:

1. An alarm clock with a proximity detector, the proximity of the human body can stop the alarm signal of an alarm clock, comprising:
an alarm clock, displaying the time, with alarm setting mechanism, a switch is closed when the time meets the setting time, a triggering signal from the power supply will trigger a sound generator and an object proximity detector into operating state;
an object proximity detector, inside said alarm clock, when a sensor of said object proximity detector detects the proximity of an object, said object proximity detector gives a triggering signal to stop the sound generator temporary, after a period of time, the sound generator is trigger again by the snooze function, said object proximity detector will stop the sound generator temporary again after detects the proximity of an object;
a sound generator, inside said alarm clock, triggering by said alarm clock when the time meets the setting time or by the snooze function, stop by the triggering signal of said object proximity detector.

2. An alarm clock as recited in claim 1, further comprising:
said object proximity detector is always in standby state without power consumption before the triggering of the alarm signal.

3. An alarm clock as recited in claim 1, wherein said alarm clock is an analog alarm clock.

4. An alarm clock as recited in claim 1, wherein said alarm clock is a digital alarm clock.

5. An alarm clock as recited in claim 1, wherein said sound generator is a speech IC.

6. An alarm clock as recited in claim 1, wherein said sound generator is a melody generator with a speaker.

7. An alarm clock as recited in claim 1, wherein said sound generator is a mechanical bell driven by a motor.

8. An alarm clock as recited in claim 1, wherein said sensor of the object proximity detector is a capacitive proximity sensor.

9. An alarm clock as recited in claim 8, wherein said capacitive proximity sensor has one metal plate.

10. An alarm clock as recited in claim 8, wherein said capacitive proximity sensor has two metal plates.

11. An alarm clock as recited in claim 8, wherein said capacitive proximity sensor uses metal wire as the sensor.

12. An alarm clock as recited in claim 1, wherein said sensor of the object proximity detector is a magnetic proximity sensor.

13. An alarm clock as recited in claim 1, wherein said object proximity detector uses the variation of frequency of an oscillator to detect the proximity of an object to said sensor.

14. An alarm clock as recited in claim 1, wherein said object proximity detector uses the variation of amplitude of an oscillator to detect the proximity of an object to said sensor.
